(19) United States
(12) Patent Application Publication
(10) Pub. No.: US 2023/0401171 A1
(43) Pub. Date: Dec. 14, 2023

(54) DYNAMIC FILESYSTEM GENERATION BASED ON CONTENT METADATA

(71) Applicant: Dell Products L.P., Round Rock, TX (US)

(72) Inventors: Joel Christner, El Dorado Hills, CA (US); Robert A. Lincourt, Franklin, MA (US); Eric Bruno, Shirley, NY (US)

(21) Appl. No.: 17/806,770

(22) Filed: Jun. 14, 2022

(51) Int. Cl. G06F 16/14; G06F 16/188; G06F 16/11

(52) U.S. Cl. CPC G06F 16/144; G06F 16/196; G06F 16/148; G06F 16/122

(57) ABSTRACT

One example method includes receiving, by an administrator from a user computer system, a query identifying content the user wants to access, and the administrator and user computer system are elements of a system that includes a group of networked user computer systems, parsing, by the administrator, the query to identify metadata included in the query, identifying, by the administrator, any content of a datastore that matches the metadata, packaging, by the administrator, the datastore content into a virtual filesystem, and exposing, by the administrator, the virtual filesystem to one of the user computer systems.

### RELATED APPLICATIONS

This application is related to (1) U.S. patent application Ser. No. ______ (attorney docket 16192.615), entitled NATIVE METADATA GENERATION WITHIN A STREAM-ORIENTED SYSTEM, and (2) U.S. patent application Ser. No. ______ (attorney docket 16192.617), entitled EXTENDING METADATA-DRIVEN CAPABILITIES IN A METADATA-CENTRIC FILESYSTEM, both of which are filed the same day herewith, and both of which are incorporated herein in their respective entireties by this reference.

### FIELD OF THE INVENTION

Embodiments of the present invention generally relate to the creation of filesystems. More particularly, at least some embodiments of the invention relate to systems, hardware, software, computer-readable media, and methods for the use of metadata, obtained in response to a query, as a basis for dynamic generation of ad hoc filesystems.

### BACKGROUND

Currently, administrators lack systems and methods by way of which data of interest can be packaged as a mountable filesystem for users or applications on another computer system. More specifically, organizations lack mechanisms for exposing a data set as a filesystem to a user who, it has been determined, should have some form of access to that data. While approaches for sharing data exist, such as file shares, SharePoint, OneDrive, and Dropbox, for example, there is no known system, mechanism, or method, for natively exposing a filesystem, on a computer system, that contains specific, identified, pieces of content related to the needs of the user or the computer system applications.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example operating environment and architecture according to some embodiments of the invention.

FIG. 2 discloses aspects of an example method according to some embodiments of the invention.

FIG. 3 discloses aspects of an example computing entity operable to perform any of the claimed methods, processes, and operations.

### DETAILED DESCRIPTION OF SOME EXAMPLE EMBODIMENTS

Embodiments of the present invention generally relate to the creation of filesystems. More particularly, at least some embodiments of the invention relate to systems, hardware, software, computer-readable media, and methods for the use of metadata, obtained in response to a query, such as a SQL (structured query language) query for example, as a basis for dynamic generation of ad hoc filesystems.

In general, example embodiments of the invention may involve the generation, on an ad hoc basis, of useful content-specific metadata. This metadata may be stored centrally in an appropriate repository. In more detail, example embodiments may embrace approaches in which the centralized metadata may be queried by a user to find particular content that is of interest to the user. For example, a user query might ask for all files that are related to “project lightning,” and which contain certain attributes. Due to the centralized nature of the metadata repository, the user may, in effect, query multiple different, and disparate, computing systems, all of which may have contributed metadata to the metadata repository. Any files or other content responsive to the user query may then be presented to the user system and/or another computer system as a filesystem. This filesystem may be virtual in the sense that it does not exist, as such, in any of the systems that contributed metadata and, rather, the filesystem has been created ad-hoc in response to a user metadata query. Various types of controls may be applied to the virtual filesystem, examples of which include encryption, access permissions, and useful lifetime, and expiration time, of the virtual filesystem.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment may reduce, or eliminate, the need for data and datasets with common attributes to be stored at a single location. An embodiment may enable a user to access data with various common user-specified attributes, notwithstanding that the data may be distributed amongst a variety of computing systems and locations and not stored only at a single system or location. An embodiment may provide for the use of controls to define the circumstances according to which the user-specified data may be accessed and employed. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. ASPECTS OF AN EXAMPLE ARCHITECTURE AND ENVIRONMENT

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, processes involving, but not limited to, the creation, modification, deletion, and management, of data and metadata.

New and/or modified data and metadata collected and/or generated in connection with some embodiments, may reside in a public or private cloud storage environment, an on-premises storage environment, and hybrid storage environments that include public and private elements. Any of these example storage environments, may be partly, or completely, virtualized. Some example cloud environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of computing environment.

In addition to the cloud environment, the operating environment may also include one or more clients or other entities that are capable of collecting, modifying, and creating, data. As such, a particular client may employ, or otherwise be associated with, one or more instances of each of one or more applications that perform such operations with respect to data. Such clients may comprise physical machines, or virtual machines (VM).

Note that as used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

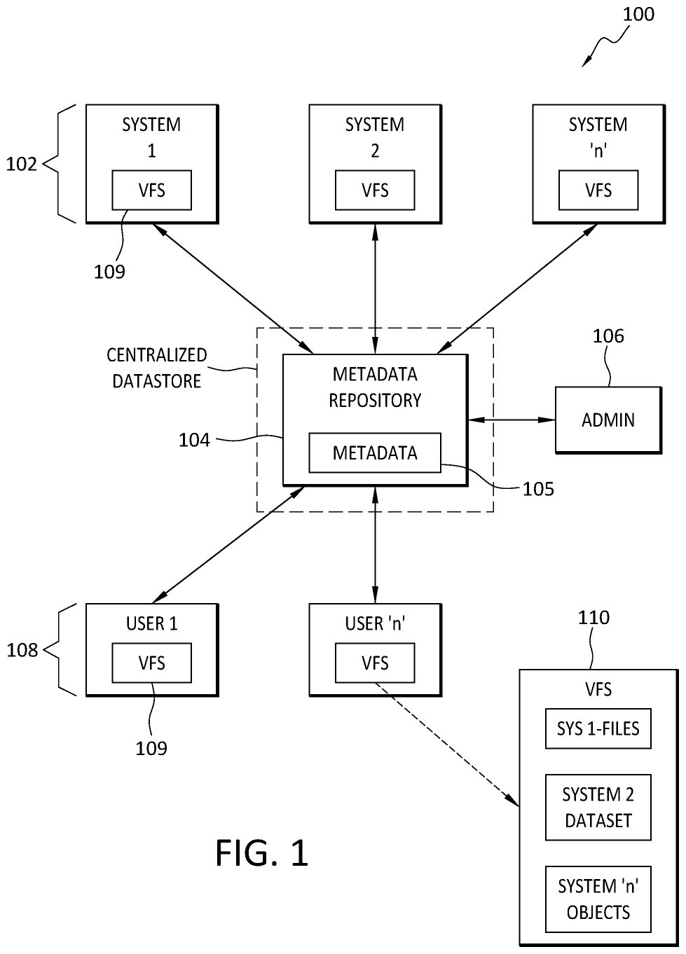

With particular attention now to FIG. 1, one example of an operating environment for embodiments of the invention is denoted generally at 100. In general, the operating environment 100 may comprise any number ‘n’ of systems 102 which, in general, may operate to generate, modify, delete, or replicate, data and metadata associated with that data. For example, the systems 102 may take the form of respective computing systems which may each comprise hardware and/or software, and which may include, for example, one or more applications that are executable to generate, modify, delete, or replicate, data and metadata associated with that data.

In connection with such data operations, one or more of the systems 102 may transmit new and modified metadata to a centralized metadata repository 104 which may or may not be integrated together with, or otherwise form a part of, a centralized datastore. In some embodiments, the metadata repository 104 may comprise one or more databases which may store metadata 105 and are operable to respond to queries by providing any metadata responsive to such queries. The metadata repository 104 may be controlled and administered by an administrator 106 which may, or may not, comprise an administrator application that may be separate from, or integrated together with, the metadata repository 104. Note that any of the functions, processes, and operations, disclosed herein as being performed by an ‘administrator’ may be performed by, or at the direction of, such an administrator application.

In general, and as disclosed in more detail elsewhere herein, the metadata may be employed to enable the construction and presentation of virtual filesystems that include the files and/or other content represented by the metadata. Various other functions that may be performed by, and/or at the direction of, an administrator 106 are disclosed elsewhere herein.

As noted, the metadata repository 104 may store metadata and may transmit metadata in response to queries. Such queries may be transmitted by one or more of the systems 102, and/or by one or more users 108. Thus, an entity that contributes to metadata to the metadata repository 104 may, or may not, also be a consumer of metadata stored, by that entity and/or one or more other entities, at the metadata repository 104.

In general, metadata 105 stored in the metadata repository 104 may be used, such as by the administrator 106, to construct, ad hoc, virtual filesystems containing, or referencing, the content to which the metadata 105 corresponds. That is, in some circumstances, the filesystem is whole and packaged in its entirety including all file data, and in other circumstances, where the filesystem is fully or partially virtual, that is, some files are sparse/virtual, and access to the virtual filesystem invokes remote access to data stored elsewhere.

As shown, a virtual filesystem (VFS) 109 may be exposed at one or more of the systems 102, and a virtual filesystem 109 may also be exposed at a user 108. As shown in FIG. 1, an example virtual filesystem 110 may comprise content associated with any one or more of the example systems 102 and/or the users 108. Thus, in the illustrative example, the virtual filesystem (VFS) 110 may comprise one or more files from ‘System 1,’ a dataset from ‘System 2,’ and one or more objects from ‘System 3.’ As will be appreciated from this example, the scope of the invention is not limited to virtual filesystems of any particular structure or content. Thus, the example virtual filesystems disclosed herein are presented only by way of illustration and are not intended to limit the scope of the invention in any way.

A virtual filesystem (VFS) according to example embodiments may be referred to herein as ‘virtual’ because a filesystem with the particular structure and content of a VFS may not exist anywhere in the operating environment 100 except in a virtual form. Thus, the structure and content of a VFS may be based upon, but transcend, the structure and content of actual filesystems found in the operating environment 100. By use of the mechanism of VFSs, example embodiments may define, and expose to a user, a virtually unlimited range of filesystem structures and content.

### B. OPERATIONAL ASPECTS OF SOME EXAMPLE EMBODIMENTS

In general, some example embodiments of the invention may operate to leverage a centralized metadata repository containing filesystem metadata and content metadata, so as to enable an administrator and/or other entity, to (1) query the centralized metadata store to identify files and folders of interest, (2) package the matching contents into a virtual filesystem, and (3) using a filesystem, examples of which are as disclosed in the ‘Related Applications’ identified herein, expose that virtual filesystem to a computer system, on the requesting computer and/or one or more remote computers, for consumption by users and applications. Further, example embodiments may provide an administrator with the ability to specify a variety of control-related parameters for the virtual filesystem including, but not limited to, (1) the type of access, such as read, write, delete, for example, that users of the remote computer system may have to the data in the virtual filesystem, and (2) a length of time for which the virtual filesystem would be available, on the remote computer system, to a user.

B.1 Content Discovery

Files, folders, and other content, of interest to a user may be discovered centrally through a centralized datastore containing primitive metadata and content metadata for all files and folders stored on the exposed filesystem on each computer running a filesystem driver, examples of which are disclosed in the ‘Related Applications’ referred to herein.

With regard to the filesystem driver, some embodiments may employ a filesystem filter driver which punts filesystem API (application program interface) calls to user space, and the entirety of the filesystem is written in user space. In another embodiment, all of this capability may be built into the kernel mode filesystem driver as well. In more detail, typical operating systems have a series of lower level drivers that provide the user space, applications, and other kernel mode applications, with APIs to certain low level functions like a filesystem, which may be considered a low level function. The network redirector may be considered a low level function, so the filesystem driver could either be in the kernel, or it could be in user space with a kernel mode filter driver for the filesystem.

With reference now to content discovery, the centralized datastore may then be queried by a user to identify matching contents, that is, contents that satisfy the user query, across computers and/or other entities in the operating environment, and the contents then packaged into a virtual filesystem that may be exposed to another computer system using the aforementioned filesystem driver. Even if the centralized datastore does not contain the content identified in response to a user query, the centralized datastore may content metadata for that content that may enable the administrator to locate that content on a computing system, and retrieve that content, or a copy of the content, for packaging into a VFS.

B.2 VFS Creation and Constraints

After the content of interest has been discovered, an administrator may package the content, which may comprise files and folders for example, into a virtual filesystem. The content may, for example, be relevant to a project that would be useful to a new team member working on that project, or to a user working on a project who needs access to the files and folders only for a specified period of time, at the end of which the VFS may expire and no longer exist or be accessible.

Additionally, or alternatively, a security access key that enables a user to access the VFS may expire, such that the user is no longer able to use the access key to access the VFS. In some embodiments, part or all of the contents of a VFS may be encrypted so that a user cannot access the content unless the user has a decryption key.

This VFS may then be exposed, such as by the administrator to one or more users, by way of the filesystem driver on the user(s) system. The VFS may appear, from a user perspective, to form a part of a directory or other file structure on the user computer system, although the content of the VFS may not actually reside on the user computer system.

Various other constraints may be applied as well to the VFS by the administrator. For example, an administrator may have the ability to define that the new virtual filesystem containing files, folders and/or other content, is available to a particular user or group of users, such as the new team member in the foregoing example, only in a specific capacity. To illustrate, the administrator may specify that one or more users may have ‘read only’ access to certain files or other content in the VFS. The administrator may specify that other users have ‘read/write’ access to certain files or other content in the VFS. As a final example, an administrator may specify that one or more users may be permitted to ‘copy’ certain content of the VFS. The foregoing are provided only by way of example and, more generally, an administrator may place any type and number of user-oriented constraints on a VFS and its contents. Further examples of constraints are described below.

In terms of user constraints that may be applied to VFS content, an administrator may have the ability to define that content of a VFS is available to a new team member only when the administrator, or other system, has determined that the user computer system, from which a query was received by the centralized datastore, is attached to the company network or VPN. In this way, an administrator may be able to ensure that the VFS is exposed in a secure environment.

B.3 VFS Content Types

In example embodiments, an administrator may have the ability to create ‘application-specific’ VFSs which expose only the files or other content that a given application is able, and/or designated, to handle. Thus, an administrator may comprise an application, such as an administrator application, that is executable to read files on a specific subject, such as ‘network security’ for example, and then package those files together into a web page accessible by a user. In this illustrative example, the web page constitutes the VFS. In another example, the administrator may query for and execute against a filesystem of files for a different subject, and so on. In still another example, the content of a VFS may be specific to a particular application, such as MS Word, so that only files of a particular type, such as .docx for example, are included in the VFS.

B.4 Administrator

In general, example embodiments of an application that obtains and packages content into a VFS, such as embodiments of the disclosed administrator application, may be written and configured without requiring any explicit knowledge, on the part of the application creator, of the metadata filesystem in connection with which the administrator application operates, and without the use of an explicit complex configuration. Thus, embodiments of the invention may be readily applied to a variety of different types of content, metadata, and filesystems.

### C. EXAMPLE CONFIGURATIONS

Assume a group of computers connected to a common network. A virtual filesystem may be presented, at one of the computers for example, to the operating system of that computer by the filesystem driver of that computer. The content of the VFS may then be consumed by users and applications, and the VFS may be identical in appearance and structure to a local filesystem that resides on the computer. However, the metadata associated with the contents of the filesystem, which may comprise primitive filesystem metadata and content-specific metadata, may be persisted in a remote datastore, enabling global discovery, from a single administrator console which may be located at a central data/metadata repository, of data and other content distributed across the computers connected to the network.

Note that as used herein, filesystem metadata may comprise, but is not limited to, information about operations performed in connection with the filesystem. For example, filesystem metadata may include the various times when a file is modified, accessed, or created. These times may be recorded by an operating system. Content metadata, on the other hand, may comprise information about specific content. Example content metadata may include the identity of the owner of a file, whether or not particular content, such as a keyword, appears in a file, and file type information such as .docx, .xls, or .json, for example.

### D. FURTHER DISCUSSION

As will be apparent from this disclosure, example embodiments may provide a variety of useful features and advantages. For example, and in contrast with conventional approaches such as Server Message Block/Common Internet Filesystem and Network Filesystem, example embodiments may operate to (1) centralize filesystem metadata, and (2) generate useful content-specific metadata. Further, embodiments involving providing access control and permissions (read, read-write), timebound access, or access based on network connectivity/disposition may be customized to particular users, content, metadata, access requirements, and other parameters, constraints, and circumstances.

### E. EXAMPLE METHODS

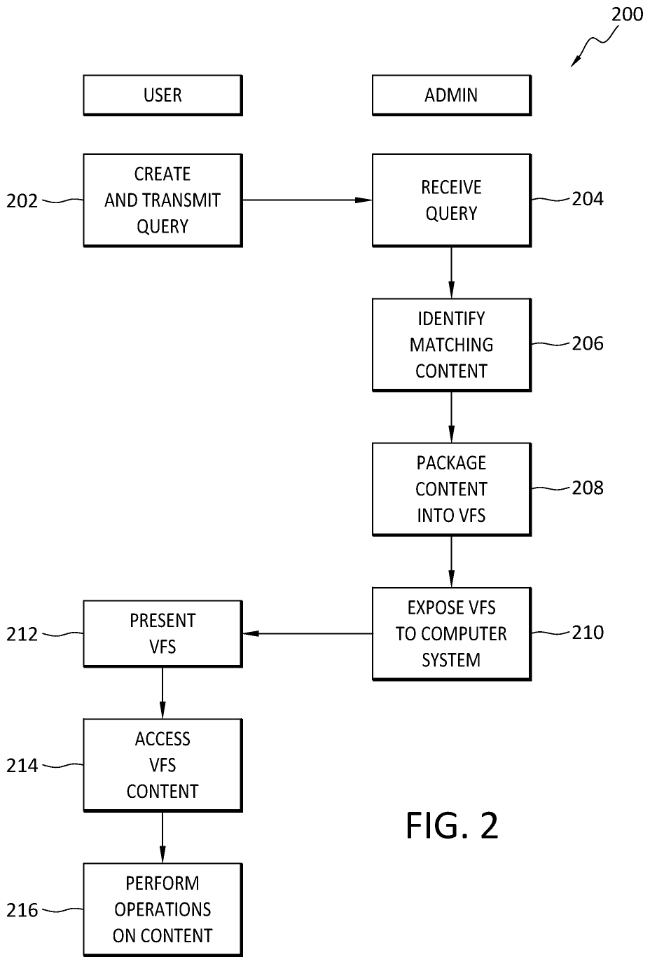

It is noted with respect to the disclosed methods, including the example method of FIG. 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 2, one example method according to some embodiments is denoted at 200. In general, the example method 200 may be cooperatively performed by a user who needs access to particular content, and an administrator that is capable of providing the user with access to that content.

The example method 200 may begin when a user generates and transmits 202 a query that identifies content that the user would like to gain access to. In a simple example, a user query may include (1) metadata, and/or (2) content, that correspond with files or other content that includes that particular metadata and/or content, such as a keyword, or word string, for example. After the query has been generated, it may be transmitted to another entity, such as an administrator associated with a central metadata/data repository for example.

The administrator may receive 204 and parse the query to identify the metadata and content included in the query. As a result of the parsing, the administrator may identify, for example, metadata, and/or content such as a key word, or word string. The identified information from the user query may then be used by the administrator to identify 206 any matching content, which may be stored at a central metadata/data repository, that fulfills the criteria specified in the user query. That is, the administrator may try to match the metadata from the query with any content that matches the metadata. Content may be considered as matching if that content includes the metadata and/or content specified in a user query. For example, a user query that specifies ‘.docx’ as metadata, would match with an MS Word file that has a .docx extension. As another example, a user query that specifies a keyword such as ‘Project X’ would match with any files or other content that include, in their title, metadata, or contents, the word string ‘Project X.’ In some embodiments, matching content may be obtained by way of a user query that identifies only metadata, and not content.

In any case, after the administrator has identified matching content 206, the administrator may then package 208 that content into a VFS. The VFS may then be exposed by the administrator 210 to the user that requested the content. On the user side, a filesystem driver at the user computer may then present the VFS 212 to the user, thus enabling the user to access 214 the content included in the VFS. After the user has accessed 214 the content, the user may then perform normal file operations on the content, such as read, write, add, modify, and delete, for example. As noted earlier, the type of access granted to the user, and the life and terms of expiration of the VFS may be specified by the administrator. In some cases, the user query may specify access parameters. For example, the user query may specify that the user only needs access to the content for 30 days. Additionally, or alternatively, the administrator may present a wizard to the user to enable the user to define a query by specifying the parameters applicable to the content to which the user desires access. Various other examples of constraints that may be applied to the VFS and its contents are disclosed elsewhere herein.

### F. FURTHER EXAMPLE EMBODIMENTS

Following are some further example embodiments of the invention. These are presented only by way of example and are not intended to limit the scope of the invention in any way.

Embodiment 1. A method, comprising: receiving, by an administrator from a user computer system, a query identifying content the user wants to access, and the administrator and user computer system are elements of a system that includes a group of networked user computer systems; parsing, by the administrator, the query to identify metadata included in the query; identifying, by the administrator, any content of a datastore that matches the metadata; packaging, by the administrator, the datastore content into a virtual filesystem; and exposing, by the administrator, the virtual filesystem to one of the user computer systems.

Embodiment 2. The method as recited in embodiment 1, wherein the administrator is hosted at a central metadata/data repository that is accessible by the user computer systems in the group of user computer systems.

Embodiment 3. The method as recited in any of embodiments 1-2, wherein the identifying comprises matching, by the administrator, the metadata from the query with metadata of the datastore.

Embodiment 4. The method as recited in any of embodiments 1-3, wherein the virtual filesystem does not exist anywhere in the system except in virtual form at the user computer system that generated the query.

Embodiment 5. The method as recited in any of embodiments 1-4, wherein the virtual filesystem is created ad hoc by the administrator in response to receipt of the query from the user computer system.

Embodiment 6. The method as recited in any of embodiments 1-5, wherein the content in the virtual filesystem comprises files and folders.

Embodiment 7. The method as recited in any of embodiments 1-6, wherein content matching the metadata at the datastore is distributed at various locations throughout the system.

Embodiment 8. The method as recited in any of embodiments 1-7, wherein the virtual filesystem is associated with one or more constraints governing access and/or use of the content of the virtual filesystem.

Embodiment 9. The method as recited in any of embodiments 1-8, further comprising assigning, by the administrator to the content of the virtual filesystem, one or more constraints governing access and/or use of the content of the virtual filesystem.

Embodiment 10. The method as recited in any of embodiments 1-9, wherein exposing, by the administrator, the virtual filesystem to one of the user computer systems, comprises the administrator interacting with a filesystem driver of the user computer system where the virtual filesystem is exposed.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

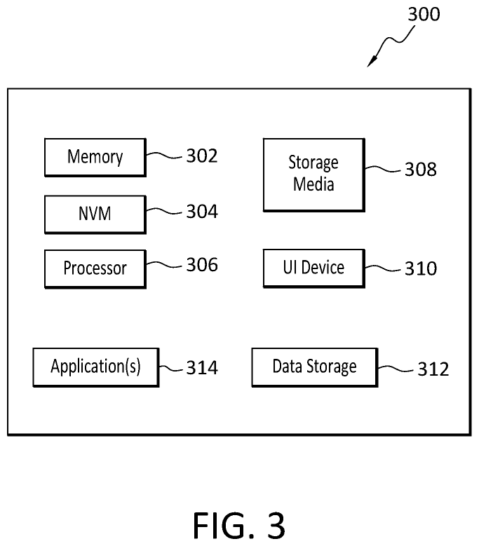

With reference briefly now to FIG. 3, any one or more of the entities disclosed, or implied, by FIGS. 1-2 and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI (user interface) device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, by an administrator from a user computer system, a query identifying content the user wants to access, and the administrator and user computer system are elements of a system that includes a group of networked user computer systems;
parsing, by the administrator, the query to identify metadata included in the query;
identifying, by the administrator, any content of a datastore that matches the metadata;
packaging, by the administrator, the datastore content into a virtual filesystem; and
exposing, by the administrator, the virtual filesystem to one of the user computer systems.

2. The method as recited in claim 1, wherein the administrator is hosted at a central metadata/data repository that is accessible by the user computer systems in the group of user computer systems.

3. The method as recited in claim 1, wherein the identifying comprises matching, by the administrator, the metadata from the query with metadata of the datastore.

4. The method as recited in claim 1, wherein the virtual filesystem does not exist anywhere in the system except in virtual form at the user computer system that generated the query.

5. The method as recited in claim 1, wherein the virtual filesystem is created ad hoc by the administrator in response to receipt of the query from the user computer system.

6. The method as recited in claim 1, wherein the content in the virtual filesystem comprises files and folders.

7. The method as recited in claim 1, wherein content matching the metadata at the datastore is distributed at various locations throughout the system.

8. The method as recited in claim 1, wherein the virtual filesystem is associated with one or more constraints governing access and/or use of the content of the virtual filesystem.

9. The method as recited in claim 1, further comprising assigning, by the administrator to the content of the virtual filesystem, one or more constraints governing access and/or use of the content of the virtual filesystem.

10. The method as recited in claim 1, wherein exposing, by the administrator, the virtual filesystem to one of the user computer systems, comprises the administrator interacting with a filesystem driver of the user computer system where the virtual filesystem is exposed.

11. A non-transitory storage medium having stored therein instructions that are executable by one or more hardware processors to perform operations comprising:
receiving, by an administrator from a user computer system, a query identifying content the user wants to access, and the administrator and user computer system are elements of a system that includes a group of networked user computer systems;
parsing, by the administrator, the query to identify metadata included in the query;
identifying, by the administrator, any content of a datastore that matches the metadata;
packaging, by the administrator, the datastore content into a virtual filesystem; and
exposing, by the administrator, the virtual filesystem to one of the user computer systems.

12. The non-transitory storage medium as recited in claim 11, wherein the administrator is hosted at a central metadata/data repository that is accessible by the user computer systems in the group of user computer systems.

13. The non-transitory storage medium as recited in claim 11, wherein the identifying comprises matching, by the administrator, the metadata from the query with metadata of the datastore.

14. The non-transitory storage medium as recited in claim 11, wherein the virtual filesystem does not exist anywhere in the system except in virtual form at the user computer system that generated the query.

15. The non-transitory storage medium as recited in claim 11, wherein the virtual filesystem is created ad hoc by the administrator in response to receipt of the query from the user computer system.

16. The non-transitory storage medium as recited in claim 11, wherein the content in the virtual filesystem comprises files and folders.

17. The non-transitory storage medium as recited in claim 11, wherein content matching the metadata at the datastore is distributed at various locations throughout the system.

18. The non-transitory storage medium as recited in claim 11, wherein the virtual filesystem is associated with one or more constraints governing access and/or use of the content of the virtual filesystem.

19. The non-transitory storage medium as recited in claim 11, wherein the operations further comprise assigning, by the administrator to the content of the virtual filesystem, one or more constraints governing access and/or use of the content of the virtual filesystem.

20. The non-transitory storage medium as recited in claim 11, wherein exposing, by the administrator, the virtual filesystem to one of the user computer systems, comprises the administrator interacting with a filesystem driver of the user computer system where the virtual filesystem is exposed.
